(19) United States
(12) Patent Application Publication
(10) Pub. No.: US 2013/0027475 A1
(43) Pub. Date: Jan. 31, 2013

(54) INK-JET DEVICE

(71) Applicants: FENG-LIN HSU, Tu-Cheng (TW); WUU-JYI LIN, Tu-Cheng (TW); CHEN-HSING CHENG, Tu-Cheng (TW); TSUNG-YU HUNG, Tu-Cheng (TW)

(72) Inventors: FENG-LIN HSU, Tu-Cheng (TW); WUU-JYI LIN, Tu-Cheng (TW); CHEN-HSING CHENG, Tu-Cheng (TW); TSUNG-YU HUNG, Tu-Cheng (TW)

(73) Assignee: HON HAI PRECISION INDUSTRY CO., LTD., Tu-Cheng (TW)

(21) Appl. No.: 13/270,248

(22) Filed: Oct. 11, 2011

(30) Foreign Application Priority Data
Jul. 26, 2011 (TW) 100126288

(51) Int. Cl. B41J 2/14

(52) U.S. Cl. 347/51

(57) ABSTRACT

An ink-jet device for jetting ink on an outer surface of a workpiece, includes an ink jet head including a nozzle, a fixing platform to fix the workpiece, a pair of light sources for emitting light to heat ink from the nozzle, and one or more reflection assemblies positioned on opposite sides of the fixing platform and below the ink jet head. The light sources are positioned in the corresponding reflection assembly. Each of the reflection assembly reflects light to be transmitted parallel to the nozzle, for heating and drying the ink on the outer surface of the workpiece.

### BACKGROUND

1. Technical Field

The present disclosure relates generally to ink-jet devices and, particularly, to an ink jet device for printing on a workpiece.

2. Description of Related Art

Generally, in the ink-jet printing process, a heater is used to dry the ink quickly in order to avoid having the ink run. However, the heater may also warm the ink jet head and cause the ink in the head to solidify. Therefore, the nozzle is easily clogged.

Therefore, there is room for improvement within the art.

### BRIEF DESCRIPTION OF THE DRAWINGS

The elements in the drawings are not necessarily drawn to scale, the emphasis instead placed upon clearly illustrating the principles of the present disclosure. Moreover, in the drawings, like reference numerals designate corresponding parts throughout the several views.

FIG. 1 is a cross-sectional view of a first embodiment of an ink-jet device, the ink-jet including an ink jet head, a fixing platform, a pair of light sources, and a pair of reflection assemblies.

FIG. 2 is a cross-sectional view of a first reflection member of the reflection assembly shown in FIG. 1.

FIG. 3 is a cross-sectional view of a second embodiment of an ink-jet device.

### DETAILED DESCRIPTION

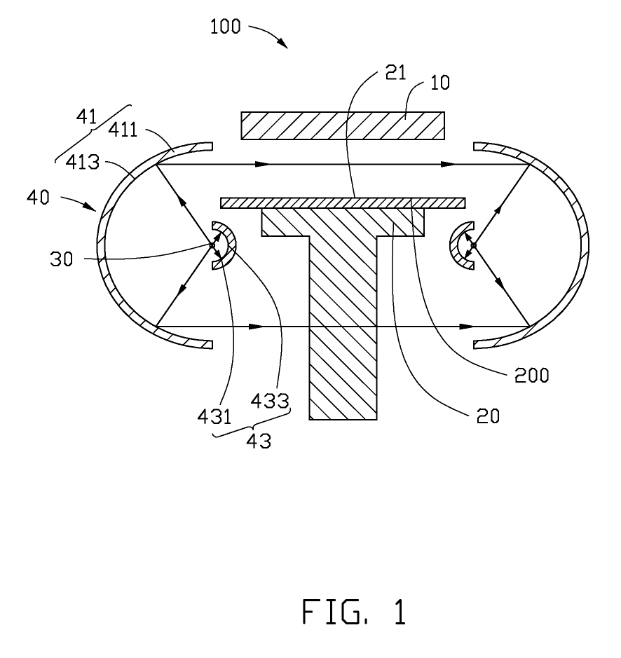

Referring to FIG. 1, a first embodiment of an ink-jet device 100 is provided to print on an outer surface 21 of a workpiece 200. The ink-jet device 100 includes an ink jet head 10, a fixing platform 20, a pair of light sources 30, and a pair of reflection assemblies 40. The head 10 includes at least one nozzle (not shown). The fixing platform 20 is configured to hold the workpiece 200. The fixing platform 20 is disposed to expose an outer surface 21 of the workpiece 200 to be ink jetted from the head 10. The pair of reflection assemblies 40 are symmetrically positioned on opposite sides of the fixing platform 20. The pair of light sources 30 are symmetrically positioned on opposite sides of the fixing platform 20 in the corresponding reflection assembly 40. In the illustrated embodiment, the light sources 30 are a plurality of infrared light sources.

Each reflection assembly 40 includes a first reflection member 41 and a second reflection member 43 opposite to the first reflection member 41. The first reflection member 41 and the second reflection member 43 are positioned adjacent to opposite sides of each light source 30, and the second reflection member 43 is disposed adjacent to the fixing platform 20.

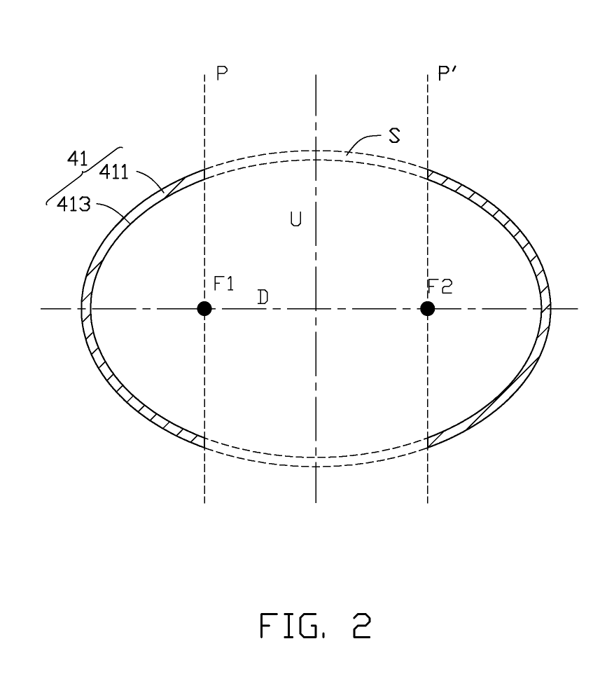

Referring also to FIG. 2, the first reflection members 41 forms portions of opposite ends of an ellipsoid S cut along corresponding planes P and P′ perpendicular to a major axis D of the ellipsoid S. In the illustrated embodiment, F1 and F2 represent two focal points of the first reflection members 41. A reference U represents a minor axis of the ellipsoid S. The major axis D is parallel to the nozzle. Each first reflection member 41 includes a main body 411 and a first reflection surface 413 formed on an inner surface of the main body 411. The first reflection surface 413 is located below the head 10. In the illustrated embodiment, the first reflection surfaces 413 are a plurality of mirrored surfaces on the inner surfaces of the main bodies 411 for reflecting light emitted from the light sources 30.

Each second reflection member 43 is substantially spherical, and includes a main body 431 and a second reflection surface 433 formed on an inner surface of the main body 431. A radius of the second reflection member 43 is less than the distance between the focal point F1 and the plane P or the focal point F2 relative to the plane P′. In the illustrated embodiment, the second reflection surfaces 433 are mirrored surfaces on the inner surfaces of the main bodies 431.

In assembly, first, the two reflection assemblies 40 are placed at the two opposite sides of the fixing platform 20. The second reflection member 43 of each reflection assembly 40 is positioned adjacent to the fixing platform 20. The first reflection surface 413 and the second reflection surface 433 are placed face to face to one another. The spherical centers of the second reflection members 43 overlap the corresponding focal points Fl and F2 of the first reflection members 41. Second, the nozzle of the head 10 is adjusted parallel to the major axis D of the first reflection member 41, above and clear of the first reflection surfaces 413, and aligned with the outer surface 21. Finally, the light sources 30 are placed at the focal points Fl and F2, respectively.

In use, the workpiece 200 is placed on the fixing platform 20 to allow the outer surface 21 to face the nozzle of the head 10. The nozzle of the head 10 jets ink to be printed on the outer surface 21. The light sources 30 emit infrared light to heat the workpiece 200. Because the light sources 30 are placed at the focal points F1 and F2, the light emitted by the light sources 30 is reflected by the first reflection surface 413, and the direction of the reflected light is parallel to the nozzle and the outer surface 21. Because the light sources 30 are also positioned at the respective center points of the second reflection members 43, the light emitted by the light sources 30 is reflected back by the second reflection surface 433 to pass through the center point of the second reflection member 43. The light reflected by the second reflection surface 433 is further reflected by the first reflection surface 413 and the reflected light is parallel to the nozzle and the outer surface 21. Thus, a heating area is formed near the fixing platform 20 and between the two first reflection surfaces 413. Because the ink on the outer surface 21 is heated in the heating area, the ink is dried faster and solidified more quickly. In other words, the flowability of the ink on the outer surface 21 is minimized to prevent the ink to be running from the edge of the workpiece 200. Because the ink is dried faster on the outer surface 21, a relatively thick layer is efficiently formed on the workpiece 200 by the ink-jet device 100.

In other embodiments, the first reflection surfaces 413 can be other portions of the ellipsoid S, and the heating area will change correspondingly. The main body 411 and the main body 431 may be in other shapes, such as substantially cuboid with a curved surface corresponding to the shape of the first reflection surface 413 and the second reflection surface 433.

Because the light sources 30 are placed at the focal points F1 and F2 of the first reflection members 41, and the center points of the second reflection members 43 overlap with the focal point F1 and F2, the light emitted by the light sources 30 are reflected by the first reflection surface 413 and the second reflection surface 433, and the reflected light is parallel to the outer surface 21. The reflected light forms the heating area near the outer surface 21. The ink on the outer surface 21 is dried faster and solidified quickly, and prevent the ink from running down the edges of the workpiece 200. Because the ink dried fast on the outer surface 201, a relatively thick layer is efficiently formed on the workpiece 200 by the ink-jet device 100. Furthermore, because the first reflection surface 413 is located below the head 10, the nozzle is not heated by the light, and thus avoids being clogged by solidified ink. Because the head 10 is away from the heating area, the head 10 also avoids being damaged by the light.

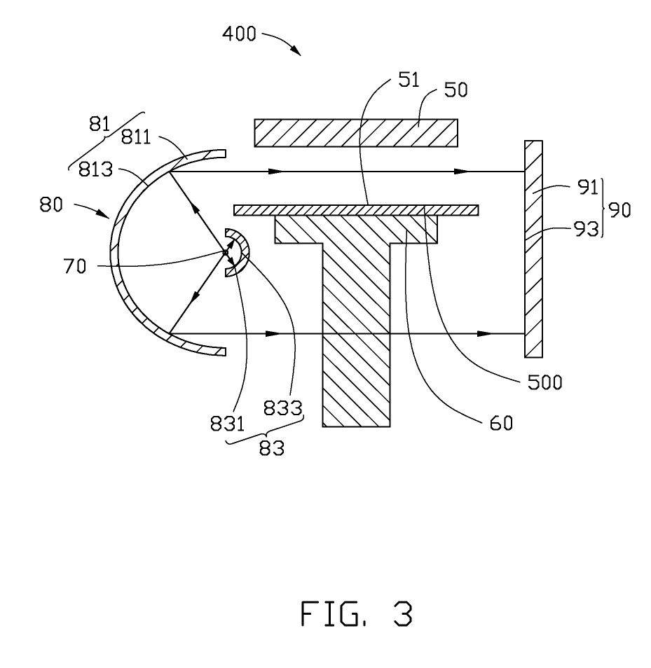

Referring to FIG. 3, a second embodiment of an ink-jet device 400 is provided to print on an outer surface 51 of a workpiece 500. The ink-jet device 400 includes an ink jet head 50, a fixing platform 60, a light source 70, a reflection assembly 80 and a planar reflection assembly 90. The head 50 includes at least one nozzle (not shown). The fixing platform 60 is configured to hold the workpiece 500. The fixing platform 60 is disposed to expose an outer surface 51 of the workpiece 500 to be ink jetted from the ink jet head 50. The reflection assembly 80 and the planar reflection assembly 90 are positioned on opposite sides of the fixing platform 60. The light source 70 is positioned in the reflection assembly 80. In the illustrated embodiment, the light source 70 is an infrared light source.

The reflection assembly 80 is the same as the reflection assembly 40 in the first embodiment, and includes a first reflection member 81 and a second reflection member 83. The first reflection member 81 includes a main body 811 and a first reflection surface 813 formed on an inner surface of the main body 811. The first reflection surface 813 is located below the head 50. The second reflection member 83 includes a main body 831 and a second reflection surface 833 formed on an inner surface of the main body 831. The light source 70 is positioned at the focal point F1.

The planar reflection assembly 90 is substantially cuboid, and includes a main body 91 and a planar reflection surface 93 formed on a surface of the main body 91 near to the fixing platform 60. The planar reflection surface 93 is substantially rectangular and perpendicular to the major axis D of the first reflection member 81.

In use, the nozzle of the head 50 jets ink to the outer surface 51. The light source 70 emits infrared light. Because of the light source 70 being placed at the focal point of the first reflection member 81 and the center point of the second reflection member 83, the reflected light reflected by the first reflection surface 813 and the second reflection surface 833 is parallel to the nozzle and the outer surface 51. Because the planar reflection surface 93 is perpendicular to the nozzle, the outgoing light is perpendicular to the planar reflection surface 93, thus the reflected light is reflected back by the planar reflection surface 93 parallel to the nozzle.

Because the light source 70 is placed at the focus F1 of the ellipsoid P, and the center point of the second reflection member 83, the light emitted by the light source 70 is reflected by the first reflection surface 813 and the second reflection surface 833, thus the reflected light is parallel to the outer surface 51. The reflected light is further reflected back by the planar reflection surface 93. The ink is heated by the light, thus the ink is dried faster and solidified on the outer surface 51 more quickly, and the ink is prevented to be running from the edges of the workpiece 500. Because the ink dried faster on the outer surface 51, a relatively thick layer is efficiently formed on the workpiece 500 by the ink-jet device 400. Furthermore, because the first reflection surface 813 is below the head 50, the reflected light is parallel to the nozzle, and thus the nozzle is not heated by the reflected light to avoid being clogged by solidified ink. Because the head 50 is away from the heating area from the light, the head 50 is also avoided being damaged by the light.

It is believed that the present embodiments and their advantages will be understood from the foregoing description, and it will be apparent that various changes may be made thereto without departing from the spirit and scope of the disclosure or sacrificing all of its material advantages.

What is claimed is:

1. An ink-jet device for jetting ink on an outer surface of a workpiece, comprising:
an ink jet head comprising a nozzle;
a fixing platform to hold the workpiece;
a pair of light sources for emitting light to heat ink from the nozzle; and
a pair of reflection assemblies positioned on opposite sides of the fixing platform and below the ink jet head;
wherein the pair of light sources are positioned in the corresponding reflection assembly; each reflection assembly reflects light into a reflected light parallel to the nozzle, for heating and drying the ink on the outer surface of the workpiece.

2. The ink-jet device of claim 1, wherein the light sources are a plurality of infrared light sources.

3. The ink-jet device of claim 1, wherein each reflection assembly comprises a first reflection member; the first reflection member comprises a first reflection surface located below the ink jet head; the first reflection surface is provided to make the light emitted by the light sources to be transmitted parallel to the nozzle.

4. The ink-jet device of claim 3, wherein a shape of the first reflection surface forms a portion of an ellipsoid; the light sources are placed in a plurality of focal points of the ellipsoid; the first reflection surface is a mirrored surface.

5. The ink jet device of claim 4, wherein each reflection assembly further comprises a second reflection member; the second reflection member comprises a second reflection surface; the second reflection surface is provided to reflect the light emitted by the light source to the first reflection surface.

6. The ink-jet device of claim 5, wherein the second reflection surface is formed on an inner surface of the second reflection member, and forms a portion of a sphere; a spherical center of the second reflection member overlaps with the focal point of the ellipsoid; the second reflection member is a mirrored surface.

7. An ink-jet device for jetting ink on an outer surface of a workpiece, comprising:
an ink jet head comprising a nozzle;
a fixing platform for fixing the workpiece;
a light source placed on one side of the fixing platform for emitting light to heat ink from the nozzle;
a reflection assembly configured in the same side of the fixing platform with the light source and below the ink jet head;
and a planar reflection assembly configured in the opposite side of the fixing platform;
wherein the light source is placed in the reflection assembly; the reflection assembly reflects the light into a reflected light parallel to the nozzle, for heating and drying the ink on the outer surface of the workpiece; the planar reflection assembly reflects the reflected light parallel to the nozzle back to the reflection assembly.

8. The ink jet device of claim 7, wherein the light source is an infrared light source.

9. The ink-jet device of claim 7, wherein the reflection assembly comprises a first reflection member; the first reflection member comprises a first reflection surface located below the ink jet head; the first reflection surface is provided to reflect the light emitted by the light source to be transmitted parallel to the nozzle.

10. The ink-jet device of claim 9, wherein a shape of the first reflection surface forms a portion of an ellipsoid; the light source is placed in the focal point of the ellipsoid; the first reflection surface is a mirrored surface.

11. The ink-jet device of claim 9, wherein the reflection assembly further comprises a second reflection member; the second reflection member comprises a second reflection surface; the second reflection surface is provided to reflect the light emitted by the light source to the first reflection surface.

12. The ink-jet device of claim 11, wherein the second reflection surface is an inner surface of the second reflection member, and forms a portion of a sphere; the spherical center of the second reflection member overlaps with the focal point of the ellipsoid; the second reflection member is a mirrored surface.

13. The ink-jet device of claim 12, wherein the planar reflection assembly comprises a planar reflection surface; the planar reflection surface is perpendicular to the nozzle; the planar reflection surface is a mirror surface.

14. An ink-jet device for jetting ink on an outer surface of a workpiece, comprising:
an ink jet head comprising a nozzle;
a fixing platform for fixing the workpiece;
at least one light source for emitting light to heat ink from the nozzle;
and at least one reflection assembly disposed at a side of the fixing platform and below the ink jet head;
wherein the at least one light source is placed in the corresponding at least one reflection assembly; the at least one reflection assembly reflects the light from the at least one light source and forms a heating area around the workpiece and below the ink jet head.

15. The ink-jet device of claim 14, wherein the light sources are a plurality of infrared light sources.

16. The ink-jet device of claim 14, wherein each reflection assembly comprises a first reflection member; the first reflection member comprises a first reflection surface below the ink jet head; the first reflection surface is provided to make the light emitted by the light sources to be transmitted parallel to the nozzle.

17. The ink-jet device of claim 16, wherein a shape of the first reflection surface forms a portion of an ellipsoid; each light source is placed in the focal point of the ellipsoid; the first reflection surface is a mirrored surface.

18. The ink-jet device of claim 16, wherein each reflection assembly further comprises a second reflection member; the second reflection member comprises a second reflection surface; the second reflection surface is provided to reflect the light emitted by the light source to the first reflection surface.

19. The ink-jet device of claim 18, wherein the second reflection surface is an inner surface formed on the second reflection member and is a portion of a hollow sphere; a center of the spherical second reflection member overlaps with the focal point of the ellipsoid; the second reflection member is a mirrored surface.
